(19) United States
(12) Patent Application Publication
(10) Pub. No.: US 2010/0084452 A1
(43) Pub. Date: Apr. 8, 2010

(54) COMBINATION OF STRIKE ROD AND BARREL FOR NAIL GUNS

(76) Inventor: YI-KUAN LEE, Ta-Li City (TW)

Correspondence Address: PHILLIP LIU, 6980, WHITEOAK DRIVE, RICHMOND, V7E4Z9, omitted

(21) Appl. No.: 12/247,979

(22) Filed: Oct. 8, 2008

(51) Int. Cl. B25C 1/00

(52) U.S. Cl. 227/120; 227/139

(57) ABSTRACT

A nail gun includes a body having a nose connected thereto and a path is defined in the nose. A magazine is engaged with an opening defined through a wall of the nose so as to provide nails into the path. Each nail includes a head and a shank. A plurality of grooves are defined axially in an inner periphery of the path. A strike rod is movably received in the path and has ridges extending radially from an outer periphery of the strike rod. The ridges are slidably engaged with the grooves in the path. A diameter of a circle formed by outer surfaces of the ridges is not less than an outer diameter of the head of the nail, so that when the strike rod hits the head of the nail and head of the nail is not deformed.

### FIELD OF THE INVENTION

The present invention relates to a nail gun and the strike rod and the inner periphery of the barrel have a polygonal cross section which is larger than the head of the nails so as to ensure that the strike rod hits every part of the head of nails.

### BACKGROUND OF THE INVENTION

A conventional nail gun 10 shown in FIGS. 1 and 2, and generally includes a nose 12 which includes a path 13 defined therein and a strike rod 3 is movably inserted in the path 13. An opening 14 is defined through a wall of the nose 12 and a magazine 2 is engaged with the opening 14 so as to feed nails 21 into the path 13. Each nail 21 includes a head 210 and a shank 212 and the inner diameter of the path 13 is larger than the outer diameter of the head 210 so that the nail head 210 is not located at a center of the path 13 when the nails 21 are fed into the path 13. Similarly, the outer diameter of the strike rod 3 is smaller than the inner diameter of the path 13. There will be a tolerance about 1-3 mm between the head 210 and the path 13, and between the strike rod 3 and the path 13. When the strike rod 3 is activated to hit the head 210 of the nail 21, the area that the strike rod 3 is slightly smaller than the head 210 of the nail 21 so that the head 210 is easily deformed as shown in the enlarged drawing in FIG. 2A, and the is leads to a unsatisfied result. Extra labor is needed to smooth the head 210 to make the head 210 to be in flush with the object.

The present invention intends to provide a strike rod which is guided to move in the path of the nose and the area of the strike rod is slightly larger than that of the head of the nail so as to hit the whole area of the head to prevent deformation of the head.

### SUMMARY OF THE INVENTION

The present invention relates to a nail gun which comprises a body having a nose connected thereto and a path is defined in the nose. An opening is defined through a wall of the nose and a magazine is connected to the opening nails so as to feed nails into the path. Each nail includes a head and a shank. A plurality of grooves are defined axially in an inner periphery of the path and a strike rod is movably received in the path. The strike rod has ridges extending radially from an outer periphery of the strike rod and the ridges are slidably engaged with the first grooves. The diameter of a circle formed by outer surfaces of the ridges is not less than an outer diameter of the head of the nail, so that the head does not deform when being hit by the strike rod.

The primary object of the present invention is to provide a strike rod having ridges which are slidably received in the grooves defined in the nose, the area of the cross section of the strike rod is not less than that of the head of the nail such that the head is hit by the strike rod and does not deform.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view of the conventional strike rod in the nose in which a nail is received;

FIG. 2 is a cross sectional view to show that the nail is hit by the conventional strike rod;

FIG. 2A shows that the head of the nail is deformed;

FIG. 3 is an exploded view to show the strike rod and the nose of the nail gun of the present invention;

FIG. 4 is a cross sectional view to show a nail is fed into the path in the nose of the present invention;

FIG. 5 is a cross sectional view to show that the nose contacts against the object to be nailed;

FIG. 6 is a cross sectional view to show that one nail is hit by the strike rod and merged into the object;

FIG. 6A shows that the head of the nail does not deform;

FIG. 7 is an end view to show the nail head and the strike rod in the path, and

FIG. 8 shows another embodiment of the nail gun

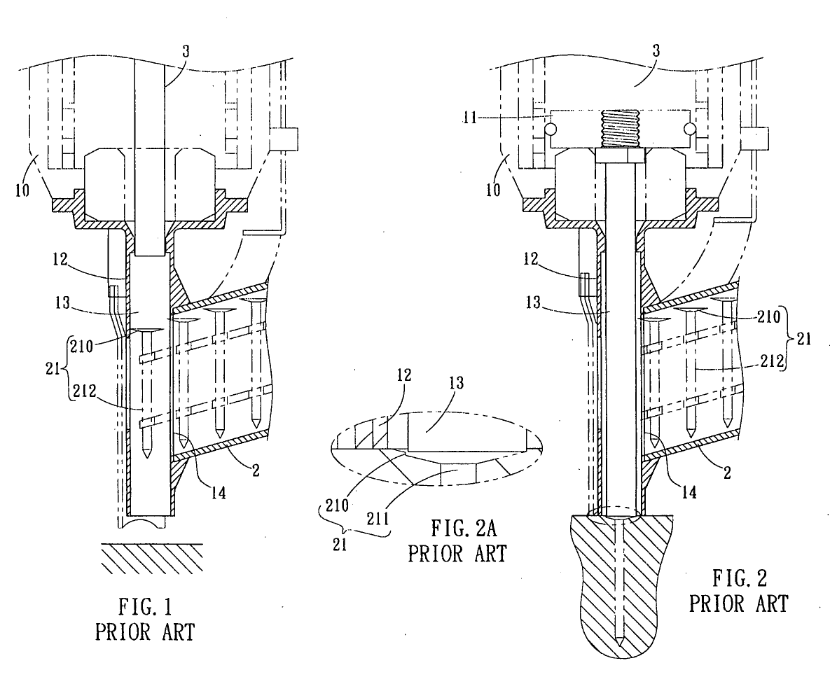

### DETAILED DESCRIPTION OF THE PREFERRED EMBODIMENT

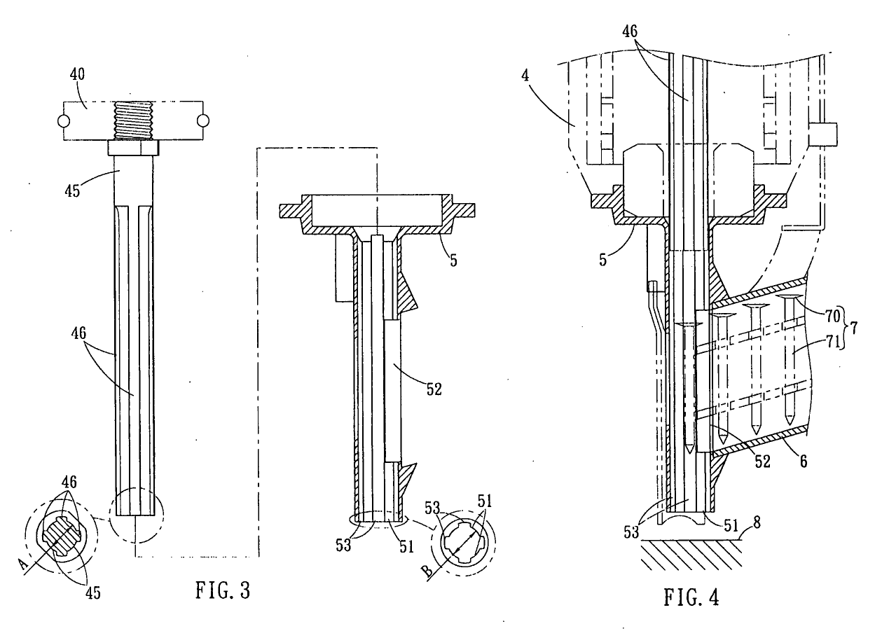

Referring to FIGS. 3 and 4, the nail gun of the present invention comprises a body 4 with a handle and a trigger (both not shown) and a nose 5 is connected the body 4. A path 51 is defined in the nose 5 and a plurality of first grooves 53 are defined axially in an inner periphery of the path 51. An opening 52 is defined through a wall of the nose 5 and a magazine 6 is engaged with the opening 52. Nails 7 are received in the magazine 6 and fed into the path 51 via the opening 52 one by one. Each nail 7 includes a head 70 and a shank 71.

A strike rod 45 is movably received in the path 51 and is moved toward the nail 7 in the path 51 when the trigger is pulled. The strike rod 45 has ridges 46 extending radially from an outer periphery of the strike rod 45 and the ridges 46 slidably engaged with the first grooves 53.

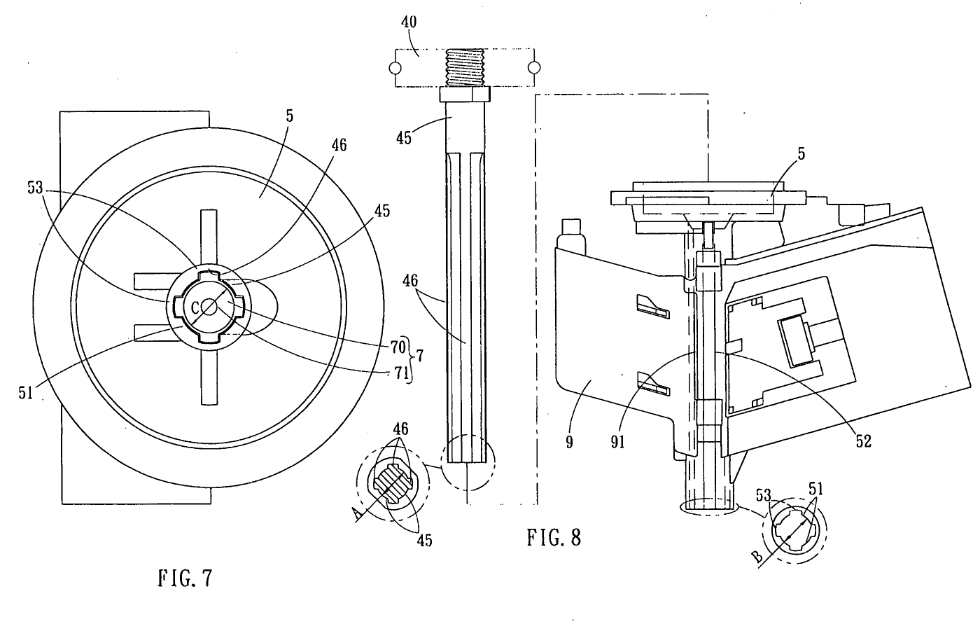

As shown in FIG. 7, the diameter “A” of a circle formed by outer surfaces of the ridges 46 is not less than an outer diameter “C” of the head 70 of the nail 7, and the diameter of the strike rod 45 is less than an inner diameter “B” of the path 51. Preferably, the cross sectional area of the strike rod 45 is larger than the cross sectional area of the head 70 of the nail 7. In other words, the whole area of the head 70 of the nail 7 will be hit by the strike rod 45 as long as the nail 7 is fed into the path 51 in the nose 5.

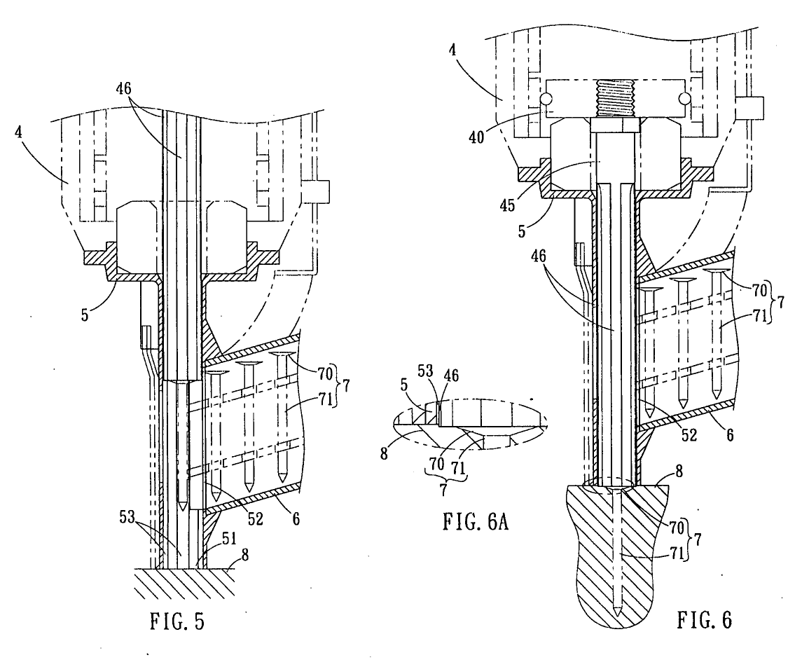

As shown in FIGS. 5 and 6, when the nose 5 contacts against the object 8 to release the safety lock (not shown), the user pulls the trigger and the strike rod 45 is activated to move to hit the head 70 of the nail 7 in the path 51. Because the area of the cross section of the head 70 of the nail 7 is enclosed by the area enclosed by the circle with, the diameter “A” of the strike rod 45, the whole head 70 is hit by the strike rod 45 and the head 70 is not deformed as shown in FIG. 6A and the top surface of the head 70 is in flush with the surface of the object 8.

FIG. 8 shows another embodiment of the nail gun wherein a cover 9 is pivotably connected to the opening 52 of the nose 5 and the cover 9 includes second grooves 91 which are located in alignment with the first grooves 53. The ridges 46 of the strike rod 45 slidably engaged with the first and second grooves 53, 91 to hit the nail 7. The size and shape of the first and second grooves 53, 91 are the same.

The first grooves 53 and the second grooves 91 are both rectangular grooves. Any known shape can be made to the first grooves 53 and the second grooves 91 such as dove-tailed grooves or semi-circular grooves. The first grooves 53 can also be extended to the whole nose 5 when needed.

While we have shown and described the embodiment in accordance with the present invention, it should be clear to those skilled in the art that further embodiments may be made without departing from the scope of the present invention.

What is claimed is:

1. A nail gun comprising:
a body having a nose connected thereto and a path defined in the nose, an opening defined through a wall of the nose and nails being fed into the path via the opening, each nail including a head and a shank, a plurality of first grooves defined axially in an inner periphery of the path, and
a strike rod movably received in the path and having ridges extending radially from an outer periphery of the strike rod, the ridges slidably engaged with the first grooves, a diameter of a circle formed by outer surfaces of the ridges being not less than an outer diameter of the head of the nail.

2. The nail gun as claimed in claim 1, wherein the diameter of the strike rod is less than an inner diameter of the path.

3. The nail gun as claimed in claim 1 further comprising a cover pivotably connected to the opening of the nose and the cover including second grooves which are located in alignment with the first grooves.

4. The nail gun as claimed in claim 1, wherein the first grooves are rectangular grooves.

5. The nail gun as claimed in claim 4, wherein the second grooves are rectangular grooves.
